(19) United States
(12) Patent Application Publication
(10) Pub. No.: US 2012/0182376 A1
(43) Pub. Date: Jul. 19, 2012

(54) Laser Processing Device

(75) Inventors: Masaki Saito, Osaka (JP); Mamoru Idaka, Osaka (JP)

(73) Assignee: KEYENCE CORPORATION, Osaka (JP)

(21) Appl. No.: 13/338,342

(22) Filed: Dec. 28, 2011

(30) Foreign Application Priority Data
Jan. 19, 2011 (JP) 2011-009022

(51) Int. Cl. B41J 2/44

(52) U.S. Cl. 347/248

(57) ABSTRACT

Provided is a laser processing device for preventing damage of the camera by return light of the laser light. A laser processing device includes a laser oscillator; a camera; a polarized beam splitter for transmitting the laser light while making a light receiving axis of the camera substantially coincide with an emission axis of the laser light; an illumination light source for generating illumination light having a wavelength substantially the same as the laser light as illumination light for illuminating the workpiece; a half mirror for making the emission axis of the illumination light substantially coincide with the emission axis of the laser light; a control unit; and a shutter for blocking the return light from the workpiece based on an output control signal of the laser light, the shutter arranged on the camera side than the polarized beam splitter in a light receiving path of the camera.

### CROSS-REFERENCE TO RELATED APPLICATIONS

The present application claims foreign priority based on Japanese Patent Application No. 2011-009022, filed Jan. 19, 2011, the contents of which is incorporated herein by reference.

### BACKGROUND OF THE INVENTION

1. Field of the Invention

The present invention relates to laser processing devices, and more specifically, to improvement of a laser processing device that processes a processing target by applying laser light.

2. Description of Related Art

A laser marking device is a laser processing device that processes a processing target (workpiece) by applying laser light, and characters, marks, figures, and the like can be printed on the workpiece by scanning an irradiation position of the laser light. In such a laser marking device, there is known a device in which the workpiece is photographed by a camera and check and adjustment of a processing position are carried out (e.g., Japanese Unexamined Patent Publication No. 2009-78280).

The laser marking device described in Japanese Unexamined Patent Publication No. 2009-78280 incorporates a camera for photographing the workpiece, and carries out the check and adjustment of the processing position at high accuracy before the processing by making a light receiving axis of the camera coincide with an emission axis of the laser light. However, if the light receiving axis of the camera is made to coincide with the emission axis of the laser light, the laser light reflected by the workpiece may enter the camera as return light and damage the camera. Thus, a wavelength selecting filter for blocking the wavelength of the laser light needs to be arranged on the light receiving axis of the camera to prevent damage of the camera.

However, it is generally difficult to design an optical system having satisfactory optical characteristics over a wide wavelength range, and in particular, it is difficult with the optical system including a highly accurate scanning section. Thus, the emission path of the laser light in the laser marking device cannot obtain the optical characteristics optimized with respect to the wavelength of the laser light and satisfactory in another wavelength band. For example, it is subjected to the influence of chromatic aberration and the like in the wavelength band different from the wavelength of the laser light. Therefore, if the wavelength of the incident light to the camera and the wavelength of the laser light differ as in the laser marking device of Japanese Unexamined Patent Publication No. 2009-78280, a clear photographed image cannot be obtained by camera photographing.

Moreover, in the laser marking device described in Japanese Unexamined Patent Publication No. 2009-78280, since the photographed image has a distortion, the processing position on a subject cannot be accurately grasped based on the photographed image other than on the photographing axis.

Furthermore, the laser marking device described in Japanese Unexamined Patent Publication No. 2009-78280 does not include an illumination light source for camera photographing but incorporates an illumination light source, and hence may be subjected to the influence of chromatic aberration and the like even if the emission axis of the illumination light source is made to coincide with the emission axis of the laser light.

### SUMMARY OF THE INVENTION

In view of the above circumstances, an object of the present invention is to provide a laser processing device capable of obtaining a high quality photographed image in which a workpiece is photographed. In particular, an object thereof is to provide a laser processing device capable of obtaining a clear photographed image by applying illumination light and photographing a workpiece using an optical system of the laser light.

It is another object thereof to provide a laser processing device capable of photographing a workpiece using an optical system of the laser light and acquiring a clear photographed image, as well as preventing damage of the camera by the return light of the laser light.

It is still another object thereof to provide a laser processing device capable of photographing a workpiece using an optical system of the laser light and obtaining a photographed image with less distortion. In particular, an object thereof is to provide a laser processing device capable of carrying out check or adjustment of the processing position at high accuracy based on the photographed image of the workpiece.

A laser processing device according to one embodiment of the present invention includes a laser generator for generating laser light for processing a processing target; a camera for photographing the processing target; a camera optical splitter for making a light receiving axis of the camera substantially coincide with an emission axis of the laser light; an illumination light source for generating illumination light having a wavelength substantially the same as the laser light, the illumination light source having an emission axis that substantially coincides with the emission axis of the laser light; and a camera shutter for blocking return light from the processing target in an openable/closable manner, the camera shutter being arranged on the camera side than the camera optical splitter.

According to such a configuration, the illumination light having the wavelength substantially the same as the laser light can be applied to the processing target and the return light from the processing target can be received by the camera through the optical path substantially coaxial with the laser light. Thus, a clear photographed image that is less likely to be subjected to the influence of chromatic aberration and the like can be obtained using the optical system for laser light optimized with respect to the wavelength of the laser light. Furthermore, the damage of the camera by the laser light can be prevented by blocking the return light of the laser light reflected by the processing target using the camera shutter.

The laser processing device according to another embodiment of the present invention further includes, in addition to the above configuration, a wavelength selecting filter for selectively passing a wavelength substantially the same as the illumination light, the wavelength selecting member being arranged on a light receiving path of the camera.

According to such a configuration, the unnecessary wavelength can be prevented from entering the camera excluding a predetermined wavelength band including the wavelength substantially the same as the illumination light. A clear photographed image thus can be obtained for the processing target.

The laser processing device according to still another embodiment of the present invention further includes, in addition to the above configuration, a scanner for scanning the emission axis of the laser light with respect to the processing target; wherein the camera optical splitter is arranged on the laser generator side than the scanner.

According to such a configuration, the irradiation position of the laser light and the photographing position by the camera can be made to coincide at high accuracy in view of the optical characteristics of the scanner. Thus, the check or adjustment of the processing position can be carried out at high accuracy based on the photographed image.

The laser processing device according to still another embodiment of the present invention further includes, in addition to the above configuration, a telecentric lens for making an emission angle of the laser light constant irrespective of an incident angle of the laser light, the telecentric lens being arranged on the processing target side than the scanner.

According to such a configuration, since the laser light is applied to the processing target at a constant angle even if the emission axis of the laser light is scanned, the accuracy of the laser processing can be enhanced, the photographed image with less distortion can be obtained, and the check or adjustment of the processing position can be carried out at high accuracy.

The laser processing device according to still another embodiment of the present invention further includes, in addition to the above configuration, an illumination optical splitter for making the emission axis of the illumination light source substantially coincide with the light receiving axis of the camera, the illumination optical splitter being arranged on the camera side than the camera optical splitter.

According to such a configuration, the light receiving path of the camera and the emission path of the illumination light can be separated on the camera side than the camera optical splitter arranged on the emission path of the laser light. Thus, the intensity of the laser light applied to the processing target can be suppressed from lowering as compared to the case in which the camera optical splitter and the illumination optical splitter are arranged on the emission path of the laser light.

In the laser processing device according to still another embodiment of the present invention, in addition to the above configuration, the illumination optical splitter is configured to transmit the return light from the processing target to the camera, and reflect the illumination light from the illumination light source to the camera optical splitter.

According to such a configuration, the transmitted light from the illumination optical splitter can be caused to enter the camera, and hence the occurrence of ghost can be suppressed and a clear photographed image can be obtained as compared to the case in which the reflected light is caused to enter the camera.

The laser processing device according to still another embodiment of the present invention further includes an optical aperture for selectively transmitting the illumination light near the emission axis, the optical aperture being arranged on the illumination light source side than the illumination optical splitter.

According to such a configuration, the illumination light not necessary for photographing can be blocked, and the light quantity reflected by the optical system on the emission path of the illumination light and enters the camera can be suppressed. Thus, for example, the lens flare is suppressed from occurring in the photographed image by the reflected light regularly reflected near the center of the lens of the telecentric lens at the time of the photographing with a shallow scan angle.

The laser processing device according to the present invention applies the illumination light having a wavelength substantially the same as the laser light to the processing target through the optical path that is substantially coaxial with the laser light, and photographs the workpiece through the optical path that is substantially coaxial with the laser light. Thus, a clear photographed image can be obtained using the optical system optimized with respect to the wavelength of the laser light.

The laser processing device according to the present invention can prevent breakage of the camera by the laser light by blocking the return light from the processing target using the camera shutter. Therefore, by making the timing of the camera photographing and the timing of the laser light output different, a photographed image of high image quality can be obtained for the processing target while preventing the damage of the camera by the laser light.

The laser processing device according to the present invention prevents the unnecessary wavelength from entering the camera by arranging the wavelength selecting filter for selectively passing the wavelength substantially the same as the laser light on the light receiving path of the camera, and thus can obtain a clear photographed image.

The laser processing device according to the present invention can apply the laser light to the processing target at a constant angle even if the emission axis of the laser light is scanned by using the telecentric lens. Thus, the accuracy of the laser processing can be enhanced and a photographed image of less distortion can be obtained, and furthermore, check or adjustment of the processing position can be carried out at high accuracy.

### BRIEF DESCRIPTION OF THE DRAWINGS

FIG. 1 is a system diagram showing one example of a schematic configuration of a laser marking system including a laser marker according to an embodiment of the present invention;

FIG. 2 is a block diagram showing a detailed configuration of the laser marker of FIG. 1;

FIGS. 3A to 3C are explanatory views showing one example of an operation of a telecentric lens of FIG. 2;

FIG. 4 is an explanatory view showing one example of an optical path passing through a half mirror of FIG. 2;

FIG. 5 is a view showing a spatial arrangement of the optical units of FIG. 2;

FIG. 6 is a perspective view showing an internal structure of a marker head of FIG. 1;

FIG. 7 is a plan view showing one configuration example of an illumination module of FIG. 5;

FIG. 8 is a cross-sectional view of the illumination module of FIG. 7 taken along line A-A;

FIG. 9 is a plan view showing one configuration example of a camera module of FIG. 5;

FIG. 10 is a side view of a camera module of FIG. 9;

FIG. 11 is a view showing one configuration example of a camera shutter of FIG. 5, showing a state in which the camera shutter is closed;

FIG. 12 is a view showing one configuration example of the camera shutter of FIG. 5, showing a state in which the camera shutter is opened; and

FIG. 13 is a view showing examples of a photographed image by the camera of FIG. 2.

### DETAILED DESCRIPTION OF PREFERRED EMBODIMENTS

<Laser Marking System 1>

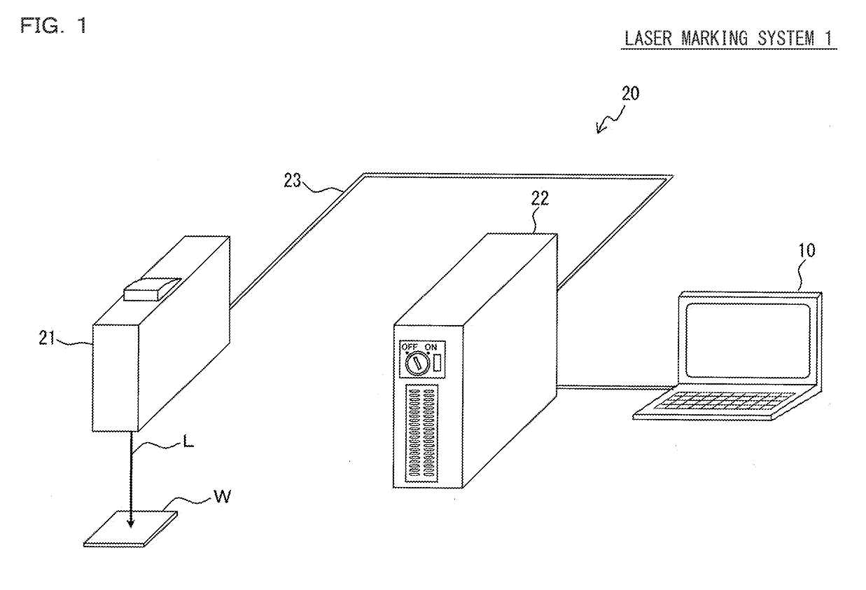

FIG. 1 is a system diagram showing one example of a schematic configuration of a laser marking system 1 including a laser processing device according to an embodiment of the present invention, where a laser marker 20 is shown as an example of the laser processing device. The laser marking system 1 is configured by the laser marker 20 for processing a workpiece W by applying laser light L, and a terminal device 10 for editing the processing conditions. The laser marker 20 includes a marker head 21 for generating and scanning the laser light L, and a marker controller 22 for carrying out the operation control of the marker head 21.

The terminal device 10 is a terminal device for controlling the laser marker 20, and may be a personal computer installed with a laser marker application program, for example. A user uses the terminal device 10 to create and edit processing setting data defining the processing conditions of the laser marker 20.

The marker controller 22 carries out the operation control of the marker head 21 based on the processing setting data received from the terminal device 10. Excitation light for laser oscillation is generated in the marker controller 22 and transmitted to the marker head 21 through an optical fiber 23.

The marker head 21 generates the laser light L based on the excitation light from the marker controller 22, and applies the laser light L to the workpiece W. Here, symbols such as characters, marks, and figures can be printed on the workpiece W by scanning the emission axis of the laser light L based on a control signal from the marker controller 22. An illumination light source and a camera (not shown) are incorporated in the marker head 21, where a photographed image of the workpiece W photographed by the relevant camera is transferred to the terminal device 10 through the marker controller 22 and displayed on a display. The user can also check or adjust the processing position on the workpiece W by browsing the photographed image.

<Laser Marker 20>

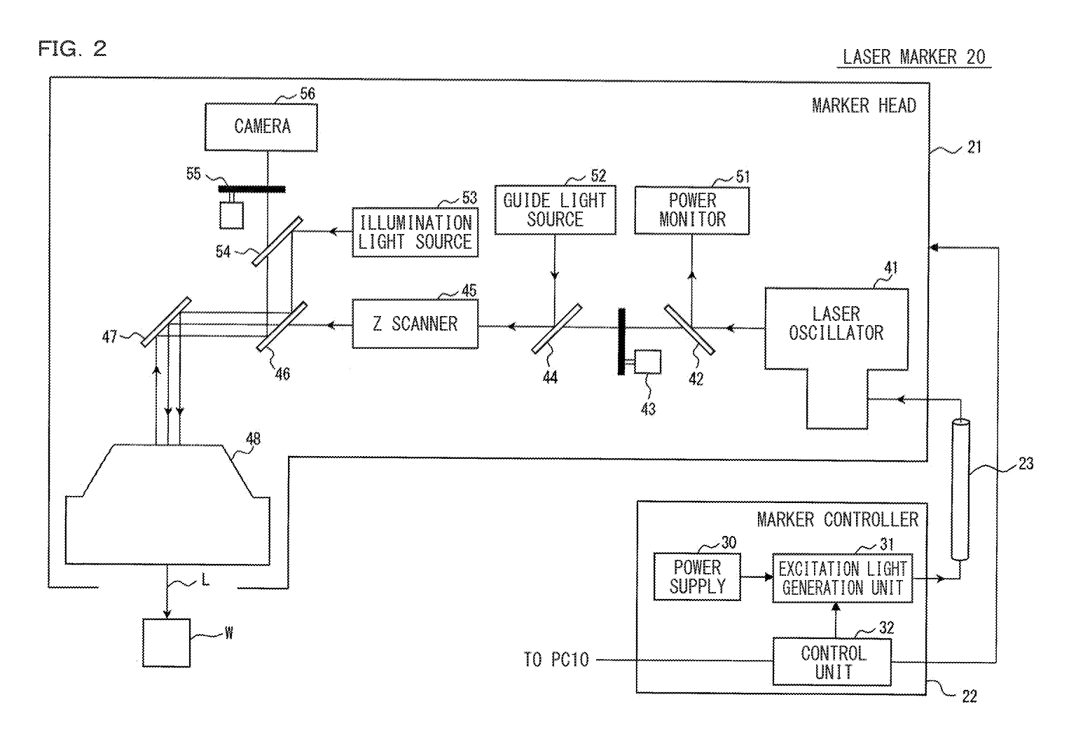

FIG. 2 is a block diagram showing a detailed configuration of the laser marker 20 of FIG. 1, and shows one example of an internal configuration of the marker head 21 and the marker controller 22.

The laser marker 20 can carry out a highly accurate laser processing by applying the laser light L through a telecentric lens 48. Furthermore, the laser marker 20 is provided with an illumination light source 53 for photographing the workpiece W and a camera 56, which are arranged such that an optical axis of the illumination light source 53 and a photographing axis of the camera 56 are coaxial with the emission axis of the laser light L. Thus, a photographed image with less distortion can be obtained through the telecentric lens 48.

The illumination light source 53 generates an illumination light including a wavelength substantially the same as the laser light L, and the camera 56 photographs the return light having the wavelength substantially the same as the laser light. Thus, the workpiece W can be photographed using the light having the wavelength substantially the same as the laser light L, and a clear photographed image can be obtained. Furthermore, by providing a camera shutter 55 on the photographing axis of the camera 56, the laser light L reflected by the workpiece W is prevented from entering the camera 56 as return light and damaging the camera 56.

<Marker Controller 22>

The marker controller 22 includes a power supply 30, an excitation light generation unit 31, and a control unit 32. The power supply 30 uses a commercial power supply to supply power to the marker head 21, the excitation light generation unit 31, and the control unit 32. The excitation light generation unit 31 generates the excitation light for laser oscillation. The excitation light is transmitted to the marker head 21 through the optical fiber 23. The control unit 32 controls the excitation light generation unit 31 and the marker head 21 based on the processing setting data transferred from the terminal device 10, and carries out output control and scanning control of the laser light L.

The laser marker 20 has a processing mode and a photographing mode for the operation modes, and can selectively switch between these modes. In other words, when a mode switch signal is input from an external device such as a PLC (Programmable Logic Controller) or a console connected to the marker controller 22, the control unit 32 determines whether the operating mode is the processing mode or the photographing mode. That is, the control unit 32 functions as an identification section for identifying one of the processing mode and the photographing mode. The processing mode is an operation mode for carrying out laser processing, and is an operation state in which an oscillator shutter 43 is opened, the camera shutter 55 is closed, and the illumination light source 53 is not lighted. A laser oscillator 41 can generate the laser light L, and an XY scanner 47 is controlled based on the processing setting data. On the other hand, the photographing mode is an operation mode for carrying out camera photographing, and is an operation state in which the oscillator shutter 43 is closed, the camera shutter 55 is opened, and the illumination light source 53 is lighted. The laser oscillator 41 is prohibited to generate the laser light L, and the XY scanner 47 is controlled by a control device such as the PLC (Programmable Logic Controller).

The control unit 32 controls the XY scanner 47 in the marker head 21, but such a control process differs depending on the operation mode of the laser marker 20. At the time of the processing mode, the scan angle of the XY scanner 47 is controlled based on the processing setting data to control the irradiation position of the laser light L. On the other hand, at the time of the photographing mode, a scan request from the PLC is input, and the scan angle of the XY scanner 47 is controlled based on the scan request. The scan request is control information of the XY scanner 47 specifying the photographing position of the camera 56. The XY scanner 47 is moved based on the scan request, and the scan response is output from the control unit 32 to the PLC if the scan angle of the XY scanner 47 coincides with the specified photographing position.

The control unit 32 controls the open/close state of the oscillator shutter 43 and the camera shutter 55 based on the operation mode of the laser marker 20, that is, based on the operation mode identified upon receiving the mode switch signal described above. At the time of the processing mode, by having the oscillator shutter 43 in the open state and the camera shutter 55 in the closed state, the laser light L can be applied while the damage of the camera 56 is prevented. On the other hand, at the time of the photographing mode, by having the oscillator shutter 43 in the closed state and the camera shutter 55 in the open state, the leakage of the laser light L is prevented while the photographing of the workpiece W by the camera 56 is enabled.

The control unit 32 also controls the laser oscillator 41 based on the operation mode of the laser marker 20. The laser light L is generated based on the processing setting data at the time of the processing mode, whereas the laser light L is not generated at the time of the photographing mode.

Furthermore, the control unit 32 controls the illumination light source 53 based on the operation mode of the laser marker 20. The illumination light source 53 is not lighted at the time of the processing mode, whereas the illumination light source 53 is lighted to illuminate the workpiece W at the time of the photographing mode.

<Marker Head 21>

The marker head 21 is configured by a laser oscillator 41, a beam sampler 42, an oscillator shutter 43, a mixing mirror 44, a Z scanner 45, a polarized beam splitter 46, an XY scanner 47, the telecentric lens 48, a power monitor 51, a guide light source 52, the illumination light source 53, a half mirror 54, the camera shutter 55, and the camera 56.

The laser oscillator 41 is a laser generator for generating the laser light L including the laser beam by absorbing the excitation light, and is configured by a laser medium, a resonator, a Q switch, and the like. The laser oscillator 41 is assumed herein as a fixed laser oscillator that performs pulse oscillation, for example, an SHG laser oscillator. The SHG laser oscillator uses YVO₄ (yttrium vanadate) crystal doped with Nd (neodymium) for the laser medium, and uses a second harmonic to output green light having a wavelength of 532 nm. The laser light having a wavelength of 808 nm is used for the excitation light for exciting the above laser medium. The laser light L generated by the laser oscillator 41 passes through the beam sampler 42, the mixing mirror 44, the Z scanner 45, the polarized beam splitter 46, the XY scanner 47, and the telecentric lens 48 in this order, and is applied to the workpiece W.

The beam sampler 42 is an optical splitter for branching a constant rate of the laser light L output from the laser oscillator 41 as a sampling beam. For example, about 3% of the entire light quantity of the input laser light L is divided by using surface reflection of a transparent substrate, and the like, and input to the power monitor 51 as a sampling beam. The power monitor 51 is a light intensity detection section for detecting the output power of the laser oscillator 41 and includes a thermosensitive element such as a thermopile, and the detection result thereof is used in the output control of the laser oscillator 41.

The oscillator shutter 43 is a leakage prevention blocking section for preventing the leakage of the laser light L by blocking the emission path of the laser light L in an openable/closable manner, and is arranged on an upstream side than the polarized beam splitter 46. The oscillator shutter 43 is arranged between the beam sampler 42 and the mixing mirror 44 herein, so that the emission path of the laser light L is blocked except for the time of the irradiation of the laser light L based on an output control signal of the laser light L. Thus, the emission path of the laser light L is blocked by the oscillator shutter 43 at the time of photographing the workpiece W by the camera 56.

The mixing mirror 44 is a light mixing optical splitter for making an emission axis of guide light substantially coincide with the emission axis of the laser light L, where the laser light L from the laser oscillator 41 is transmitted and the guide light from the guide light source 52 is reflected so that they are both sent to the Z scanner 45. The guide light source 52 is a light source device for generating the guide light for displaying the processing position on the workpiece W, and includes a light emitting element such as an LD (Laser Diode). The symbol pattern to be printed can be visually recognized as an afterimage of the irradiation spot by the lighting control of the guide light and the high-speed scanning of the emission axis of the guide light.

The Z scanner 45 is a beam diameter control section for adjusting the beam diameter of the laser light L, and includes two lenses arranged on the optical axis of the laser light L, where the beam diameter of 2 mmφ of the laser light L can be enlarged to a maximum of 8 mmφ, for example, by changing the relative distance of such lenses. The defocus control of lowering the energy density in the spot can be carried out by enlarging the spot diameter of the laser light.

The polarized beam splitter 46 is a camera optical splitter, arranged on the upstream side than the XY scanner 47 on the emission path of the laser light L, for transmitting the laser light L from the Z scanner 45 and making the light receiving axis of the camera 56 substantially coincide with the emission axis of the laser light L. In other words, the return light entering the telecentric lens 48 and going back the emission path of the laser light L of the reflected light by the workpiece W is reflected by the polarized beam splitter 46 so as to separate from the emission axis of the laser light L and directed toward the camera 56. The polarized beam splitter 46 reflects the illumination light that entered through the half mirror 54 toward the XY scanner 47, and makes the emission axis of the illumination light coincide with the emission axis of the laser light L. For example, if the laser light L of P polarized light is generated by the laser oscillator 41, the P polarized light component is selectively transmitted, and the laser light L is transmitted while the return light including the S polarized light component and the irradiation light are respectively reflected by using the polarized beam splitter 46 for reflecting the S polarized light component.

The XY scanner 47 is a scanning optical system for two-dimensionally scanning the emission axis of the laser light L, and includes an X direction scanning mirror and a Y direction scanning mirror for reflecting the laser light L and a drive unit for rotating these scanning mirrors. The scanning mirror is called a galvano-mirror, and is arranged on the emission path of the laser light L. The XY scanner 47 turns the scanning mirror based on a scanning control signal from the marker controller 22.

The telecentric lens 48 is an emission optical system for emitting the laser light L toward the workpiece W, and is arranged on the downstream side than the XY scanner 47, that is, the workpiece W side in the emission path of the laser light L. The telecentric lens 48 is configured by a plurality of optical lenses and a cover glass, and includes an object side telecentric optical system in which the field angle on the workpiece W side is about 0°. That is, the telecentric lens 48 emits the laser light L toward the workpiece W such that the main light ray of the laser light becomes substantially parallel to the lens optical axis regardless of the incident angle of the laser light L. The laser light L that passed the polarized beam splitter 46 is emitted toward the workpiece W by the telecentric lens 48.

The illumination light source 53 is a light source device adapted to generate illumination light for illuminating the workpiece W, and includes a light emitting element such as an LED (light emitting diode). The illumination light source 53 generates the illumination light having the wavelength substantially the same as at least the laser light L, and emits the same to the half mirror 54.

The half mirror 54 is an illumination optical splitter, arranged on a light receiving path of the camera 56, for transmitting the return light from the polarized beam splitter 46 and making the emission axis of the illumination light substantially coincide with the light receiving axis of the camera 56. In other words, the half mirror 54 transmits the return light from the polarized beam splitter 46 to enter the camera 56, and reflects the illumination light from the illumination light source 53 toward the polarized beam splitter.

The camera shutter 55 is a camera protecting blocking section for blocking the light receiving path of the camera 56 in an openable/closable manner to prevent the return light from entering the camera 56 at the time of the irradiation of the laser light L, and is arranged on the upstream side than the polarized beam splitter 46. That is, the camera shutter 55 is arranged on the camera 56 side than the polarized beam splitter 46, and when the processing target is irradiated with the laser light L, the camera shutter 55 blocks the return light reflected by the processing target, the return light being passed through a wavelength selecting filter 566 to be described later. In this case, the camera shutter 55 is arranged between the half mirror 54 and the camera 56, opened and closed based on the output control signal of the laser light L, and blocks the light receiving path of the camera 56 at least during the irradiation period of the laser light L. Thus, the camera 56 can be prevented from being damaged by the return light of the laser light L by making the timing of the laser irradiation and the timing of the camera photographing different.

The camera 56 is an imaging unit for photographing the workpiece W and generating a photographed image, and the camera 56 carries out photographing based on an imaging control signal from the marker controller 22 and outputs the obtained photographed image to the marker controller 22. Herein, the camera 56 is assumed to receive the light having the wavelength substantially the same as the laser light and generate the photographed image.

At the time of photographing the workpiece W using the camera 56, the illumination light source 53 is lighted, and the workpiece W is irradiated with the illumination light through the half mirror 54, the polarized beam splitter (PBS) 46, the XY scanner 47, and the telecentric lens 48. In this case, the reflected light by the workpiece W of the illumination light is received by the camera 56 through the telecentric lens 48, the XY scanner 47, the PBS 46, and the half mirror 54. Here, the light receiving axis of the camera 56 is separated from the emission axis of the laser light L in the PBS 46. That is, the PBS 46 is arranged on the light receiving path of the camera 56.

<Telecentric Lens 48>

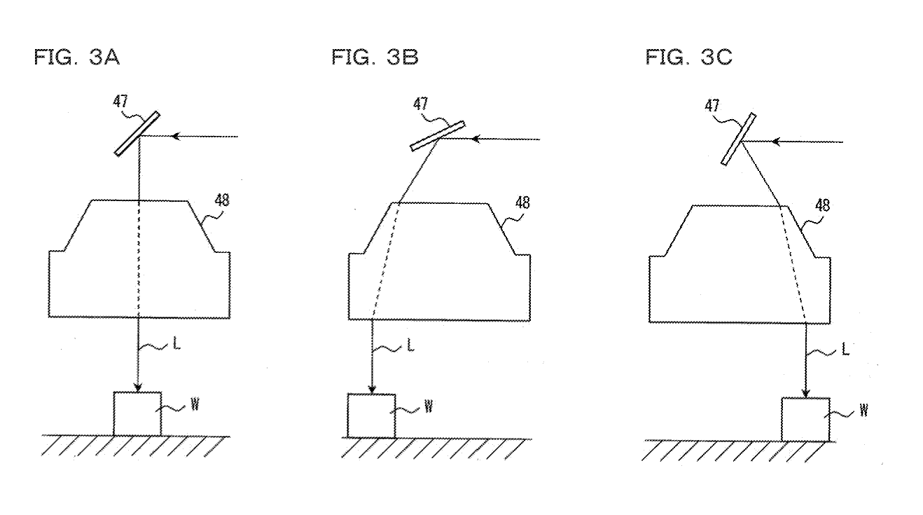

FIGS. 3A to 3C are explanatory views showing one example of the operation of the telecentric lens 48 of FIG. 2. FIG. 3A shows a case in which the laser light L is applied to the middle of a printable area, FIG. 3B shows a case in which the laser light L is applied to near the left end of the printable area, and FIG. 3C shows a case in which the laser light L is applied to near the right end of the printable area.

The telecentric lens 48 emits the laser light L such that the main light ray thereof becomes substantially parallel to the optical axis of the telecentric lens 48 regardless of the incident angle of the laser light L. Thus, the spot diameter of the laser light L formed on the workpiece W does not change and highly accurate laser processing can be carried out even if the scan angle of the XY scanner 47 becomes deep and the incident angle to the telecentric lens 48 becomes large.

In such a laser marker 20, the photographed image with less distortion can be obtained by photographing the workpiece W using the camera 56 having a light receiving axis substantially coincide with the emission axis of the laser light L. In other words, the photographed image does not distort even if the scan angle of the XY scanner 47 becomes deep and the incident angle to the telecentric lens 48 becomes large. Furthermore, the surrounding image also does not distort in the photographed image regardless of the scan angle of the XY scanner 47. Therefore, the check or adjustment of the processing position can be made at high accuracy based on the photographed image with less distortion.

<Half Mirror 54>

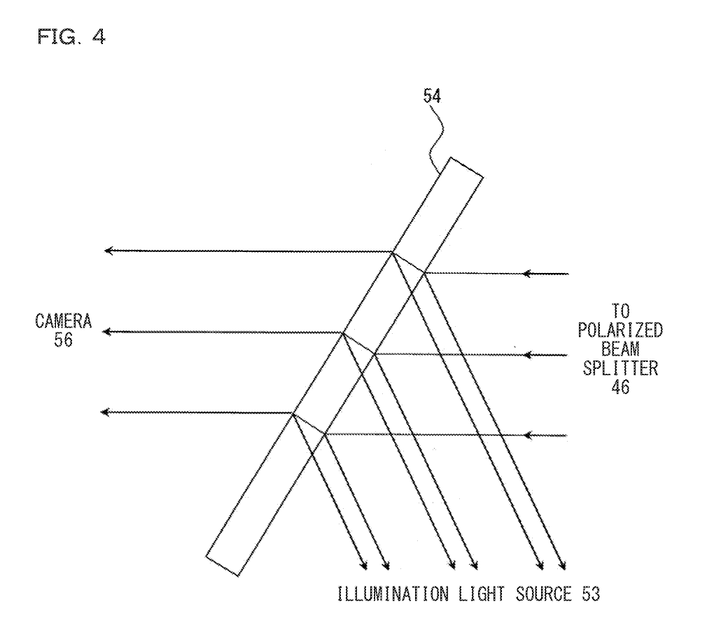

FIG. 4 is an explanatory view showing one example of an optical path that passes the half mirror 54 of FIG. 2. The reflection at the half mirror 54 occurs at a first surface to which the light enters, and also at a second surface opposing the first surface. Thus, a ghost in which the image appears to be doubled occurs if the reflected light of the half mirror 54 is photographed. Such a problem does not arise if a transmitted light is photographed.

Thus, a clear photographed image can be obtained by arranging the camera 56 in a direction in which the return light that entered from the polarized beam splitter 46 is emitted through the half mirror 54, and arranging the illumination light source 53 so that the illumination light reflected by the half mirror 54 enters the polarized beam splitter 46.

<Spatial Arrangement of Optical Unit>

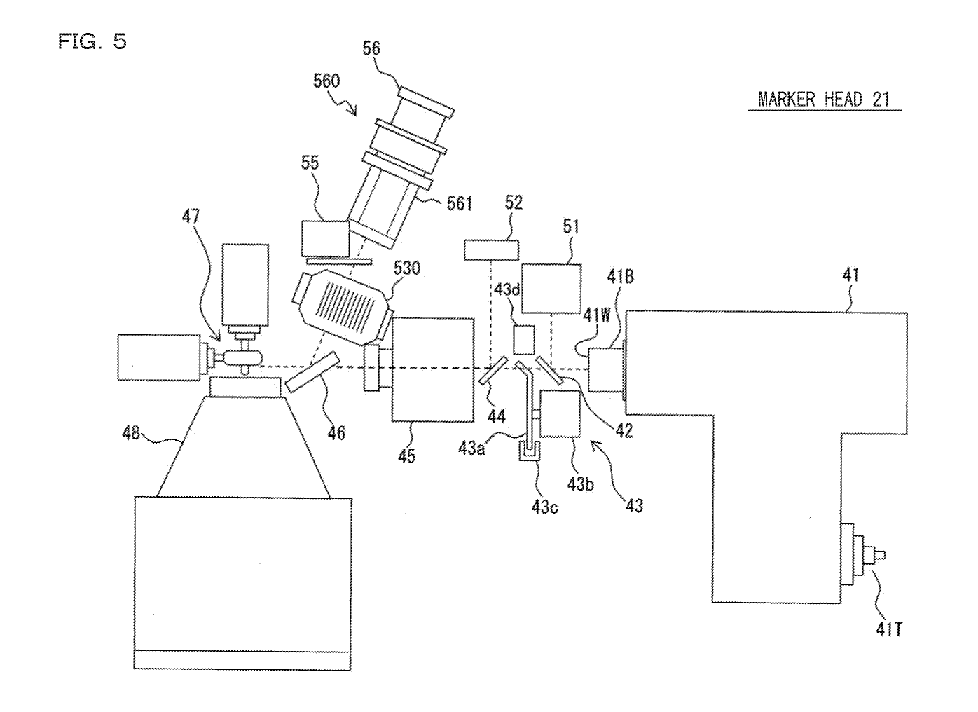

FIG. 5 is a view showing a spatial arrangement of the optical units 41 to 48, 51 to 56 of FIG. 2. The laser oscillator 41, the beam sampler 42, the mixing mirror 44, the Z scanner 45, the polarized beam splitter 46, and the XY scanner 47 are aligned and arranged in a substantially straight line in the horizontal direction, and the laser light L is passed through a straight path from the laser oscillator 41 to the XY scanner 47, bent downward by the XY scanner 47, and enters the telecentric lens 48. With such a configuration, the number of times the laser light is bent can be reduced so that error caused by the variation of the optical units 41 to 47 can be suppressed and the accuracy of laser processing can be enhanced.

The laser oscillator 41 is formed in a T-shape, where the excitation light is input from an input terminal 41T at the lower right, and the laser light L is output from an output window 41W formed at the distal end of an output tube 41B at the upper left.

The beam sampler 42 and the mixing mirror 44 are arranged inclined by 45° with respect to the emission axis of the laser light L.

The oscillator shutter 43 is configured by a light shielding plate 43a, a rotation drive unit 43b, a position detection unit 43c, and a reflected light absorbing device 43d. The light shielding plate 43a is a light shielding section for blocking the optical path of the laser light L, and is made from a metal plate, for example. The rotation drive unit 43b is a drive section for rotating the light shielding plate 43a, and a rotary solenoid is used, for example. When the rotation drive unit 43b rotates the light shielding plate 43a, the optical path of the laser light L can be blocked in an openable/closable manner. The position detection unit 43c is a detection section for detecting the rotation position of the light shielding plate 43a, and a photocoupler is used, for example. The reflected light absorbing device 43d absorbs the laser light L reflected by the light shielding plate 43a and prevents the laser light L from scattering.

The polarized beam splitter 46 is arranged inclined by about 56.6° with respect to the emission axis of the laser light L, and the incident angle of the laser light L is made to substantially coincide with a Brewster's angle. The laser light L thus can be transmitted almost 100%. The return light is reflected by the polarized beam splitter 46, and is directed upward with an angle of about 66.8° with respect to the emission axis of the laser light L in the horizontal direction.

The illumination module 530 is a module in which the illumination light source 53 is arranged on a near side in the plane of drawing and the half mirror 54 is arranged on a far side in the plane of drawing, where the illumination light emitted from the nearside toward the far side is reflected by the half mirror 54 and enters the polarized beam splitter 46 in the lower left direction. The return light that entered from the polarized beam splitter 46 is transmitted through the half mirror 54 and enters a camera module 560 in the upper right direction.

The camera module 560 is a module configured by the camera 56 and a lens barrel 561, where the camera 56 is attached in a replaceable manner with respect to the lens barrel 561.

<Internal Structure of Marker Head 21>

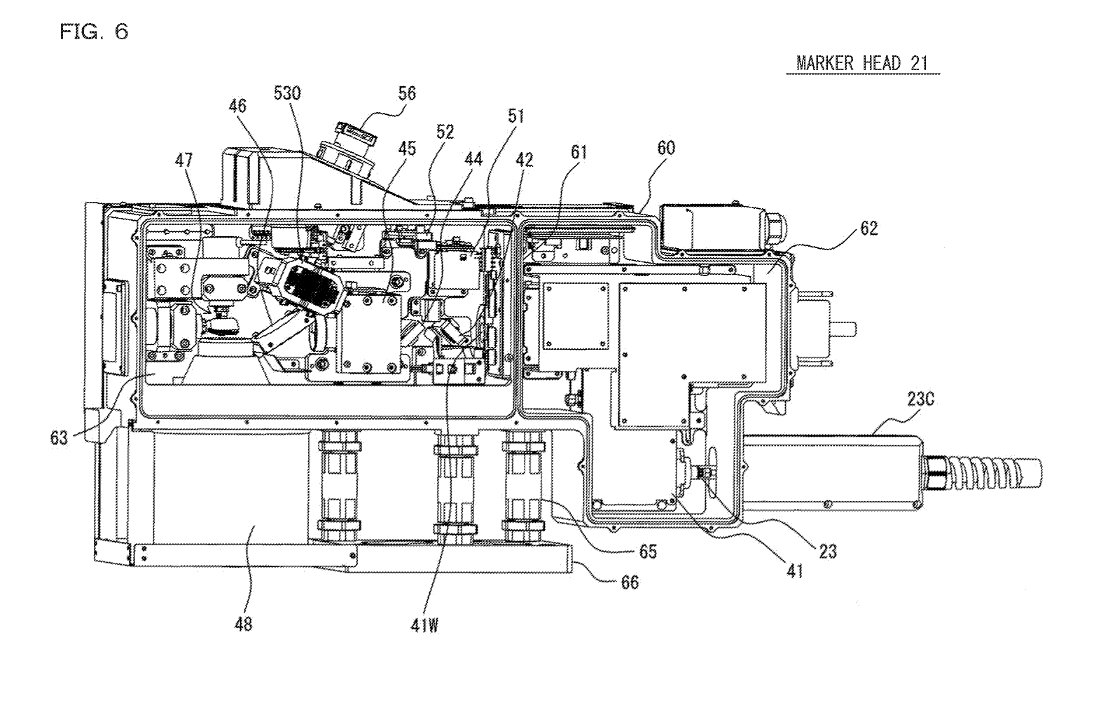

FIG. 6 is a perspective view showing an internal structure of the marker head 21 of FIG. 1. The marker head 21 has each optical unit excluding the telecentric lens 48 and the camera 56 of the optical units 41 to 48 and 51 to 56 shown in FIG. 2 accommodated in a housing frame 60.

The housing frame 60 is a die-cast frame integrally molded from a metal such as aluminum, and is divided into two accommodating portions 62, 63 by a partition plate 61 integrally molded therewith. By integrally molding the housing frame 60 and fixing each optical unit 41 to 48 and 51 to 56 in the housing frame 60, the arrangement accuracy of the optical units can be enhanced and the accuracy of the laser processing can be enhanced.

The accommodating portion 62 on the right side accommodates the laser oscillator 41, and has a connecting unit 23C of the optical fiber 23 attached to the outer wall so that the optical fiber 23 passes through the wall surface. The excitation light enters the lower right part of the laser oscillator 41 through the optical fiber 23, and the laser light L is emitted from the output window 41W at the upper left part of the laser oscillator 41. The output window 41W is arranged at the distal end of the output tube 41B of the laser oscillator 41 passing through the partition plate 61, that is, the accommodating portion 63 on the left side.

The accommodating portion 63 on the left side accommodates each optical unit excluding the laser oscillator 41, the telecentric lens 48, and the camera 56. The accommodating portion 63 has a dustproof structure thus preventing lowering in the accuracy of the laser processing by the influence of dust.

Three height adjustment legs 65 for supporting the marker head 21 are attached to the housing frame 60. Each height adjustment leg 65 is a circular column shaped supporting member, and its length can be individually adjusted. Each height adjustment leg 65 is attached to a common attachment plate 66, and the marker head 21 is installed on a working table and the like by way of the attachment plate 66.

<Illumination Module 530>

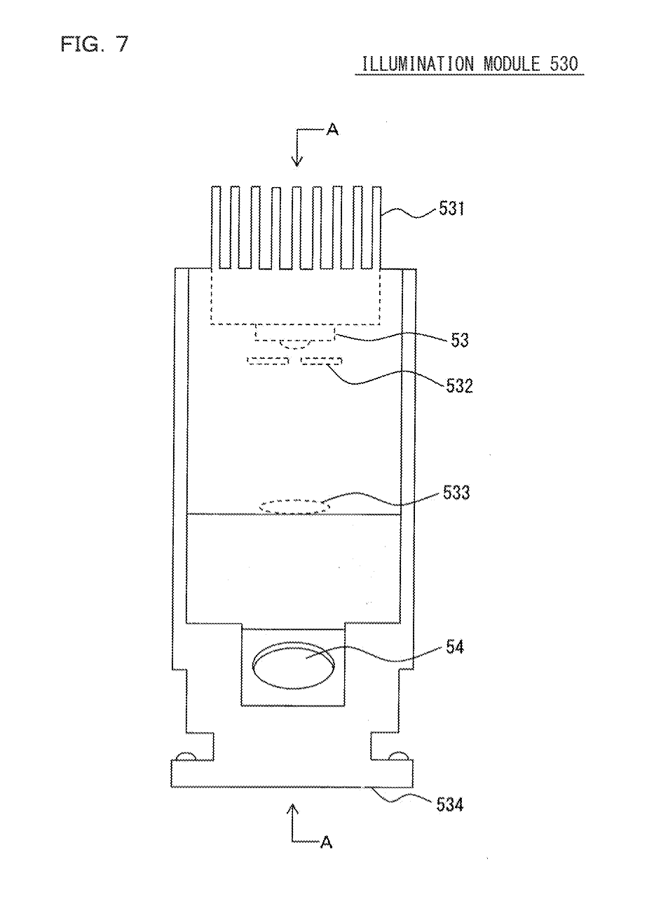

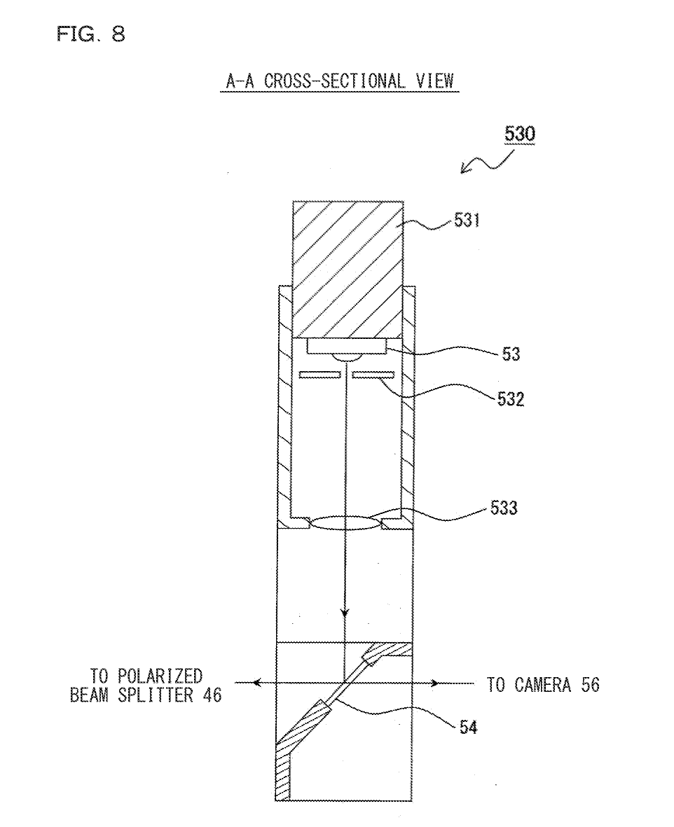

FIG. 7 is a plan view showing one configuration example of the illumination module 530 of FIG. 5. FIG. 8 is a cross-sectional view of the illumination module 530 of FIG. 7 taken along line A-A. The illumination module 530 is configured by an illumination light source 53, a heat sink 531, an aperture 532, a light collecting lens 533, and a half mirror 54, where an attachment surface 534 is securely attached to the housing frame 60.

The heat sink 531 is a heat radiation plate having multiple heat radiation fins, and is attached to the rear surface of the illumination light source 53. The aperture 532 is an optical aperture that transmits only the illumination light in the vicinity of the emission axis, and includes a light shielding plate formed with a small transmitting window on the emission axis of the illumination light. The illumination light that transmitted through the aperture 532 passes through the light collecting lens 533 and enters the half mirror 54. The half mirror 54 is arranged inclined by 45° with respect to the light receiving axis of the camera 56.

By arranging the aperture 532 on the front side of the illumination light source 53, the light not necessary for photographing can be blocked and the light quantity of the irradiation light can be suppressed. Thus, lens flare can be suppressed from generating in the photographed image. In particular, the illumination light is suppressed from being reflected by the telecentric lens 48 thus generating the lens flare in the photographed image when the XY scanner 47 has a shallow scan angle.

<Camera Module 560>

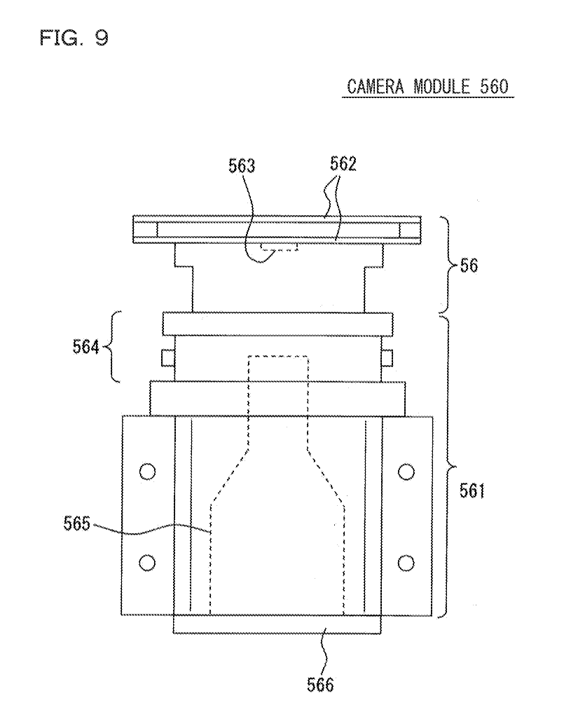

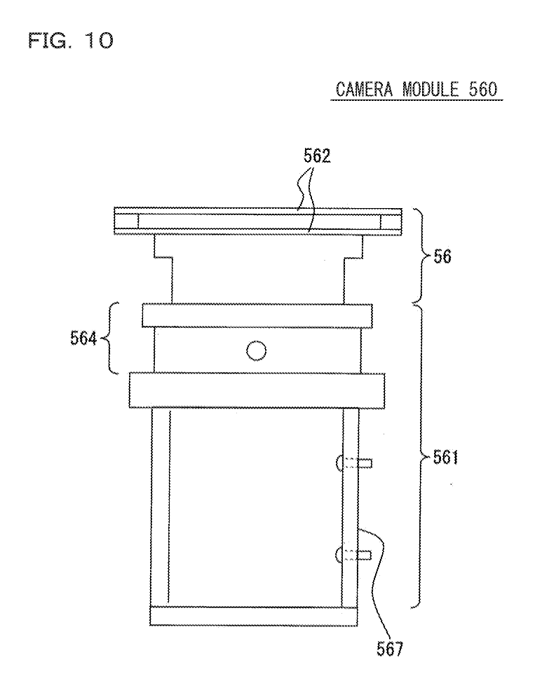

FIG. 9 is a plan view showing one configuration example of the camera module 560 of FIG. 5, and FIG. 10 is a side view of the camera module 560 of FIG. 9. The camera module 560 includes the camera 56 and the lens barrel 561.

The camera 56 includes a circuit substrate 562 provided with an imaging element 563 such as a CCD (Charge Coupled Device), and is removably attached to the lens barrel 561.

The lens barrel 561 includes a camera attaching portion 564, an imaging lens 565 and the wavelength selecting filter 566, and has an attachment surface 567 fixed to the housing frame 60. The camera attaching portion 564 is a screw-in type mount portion that engages with the camera 56, and can adjust the attachment position of the camera 56. The imaging lens 565 is a light receiving optical system for causing the imaging element 563 to image the return light.

The wavelength selecting filter 566 is an optical member for preventing disturbance light from appearing in the photographed image, and is arranged on the light receiving path of the camera 56 to selectively transmit the wavelength substantially the same as the illumination light of the illumination light source 53. In other words, the wavelength selecting filter 566 selectively passes the return light from the processing target illuminated with the illumination light. By using the wavelength selecting filter 566, a clear photographed image can be obtained by entering the return light having the wavelength substantially the same as the illumination light to the camera 56 and removing the wavelength component not necessary for photographing.

The optical system of the marker head 21 needs to be designed such that the optimum optical characteristics are obtained for the wavelength of the laser light L to carry out highly accurate laser processing. In particular, the telecentric lens 48 is designed to suppress the influence of chromatic aberration and the like with respect to the wavelength of the laser light L. Thus, a clear photographed image can be obtained by photographing the return light having the wavelength substantially the same as the laser light L. Furthermore, the influence caused by the disturbance light can also be suppressed. The wavelength selecting filter 566 merely needs to be able to selectively pass the band including the wavelength substantially the same as at least the laser light L.

Moreover, by arranging the wavelength selecting filter 566 on the camera 56 side than the polarized beam splitter 46, the lowering of the emission intensity of the laser light L can be suppressed as compared to the case in which the wavelength selecting filter 566 is arranged on the workpiece W side than the polarized beam splitter 46.

<Camera Shutter 55>

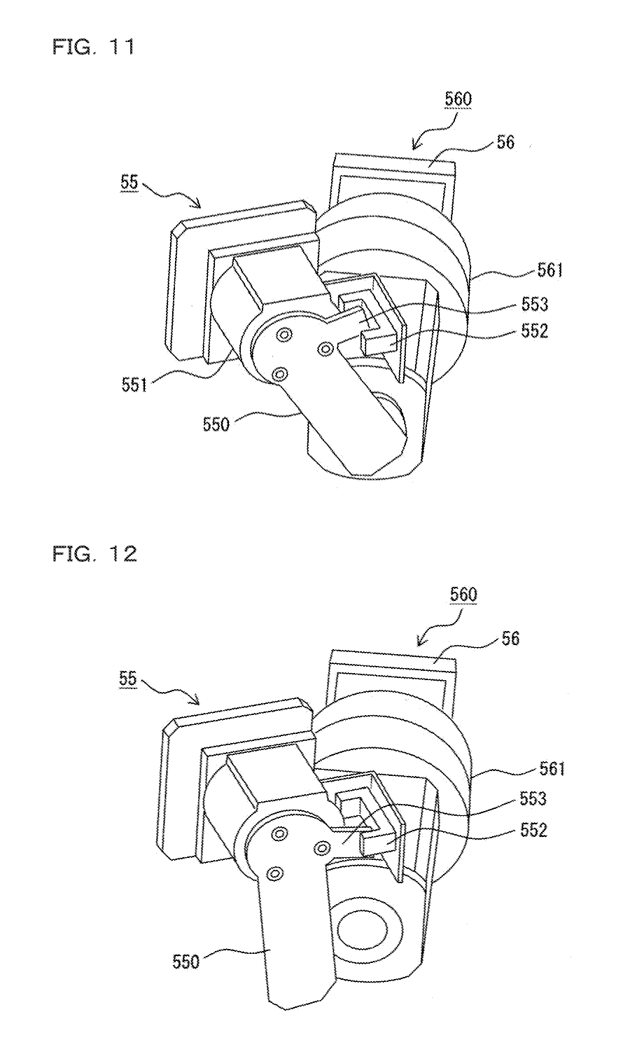

FIG. 11 and FIG. 12 are views showing one configuration example of the camera shutter 55 of FIG. 5, where FIG. 11 shows a state in which the camera shutter 55 is closed, and FIG. 12 shows a state in which the camera shutter 55 is opened.

The camera shutter 55 is configured by a light shielding plate 550, a rotation drive unit 551, and a position detection unit 552. The light shielding plate 550 is a light shielding section for blocking the optical path of the laser light L, and is made from a metal plate, for example. The rotation drive unit 551 is a drive section for rotating the light shielding plate 550, and a rotary solenoid is used, for example. When the rotation drive unit 551 rotates the light shielding plate 550, the incident light to the camera 56 can be blocked in an openable/closable manner. The position detection unit 552 is a detection section for detecting the rotation position of the light shielding plate 550, and includes a photocoupler for detecting a position of a position detecting projection 553 that rotates with the light shielding plate 550.

FIG. 11 shows a state of the camera shutter 55 at the time other than the camera photographing. If the light receiving path of the camera 56 is blocked by blocking the light receiving unit of the lens barrel 561 with the light shielding plate 550, the return light from the workpiece W does not enter the camera 56.

FIG. 12 shows a state of the camera shutter 55 at the time of the camera photographing. If the light shielding plate 550 is turned from the state of FIG. 11 thus exposing the light receiving unit of the lens barrel 561 to open the light receiving path of the camera 56, the return light from the workpiece W enters the camera 56.

<Photographed Image>

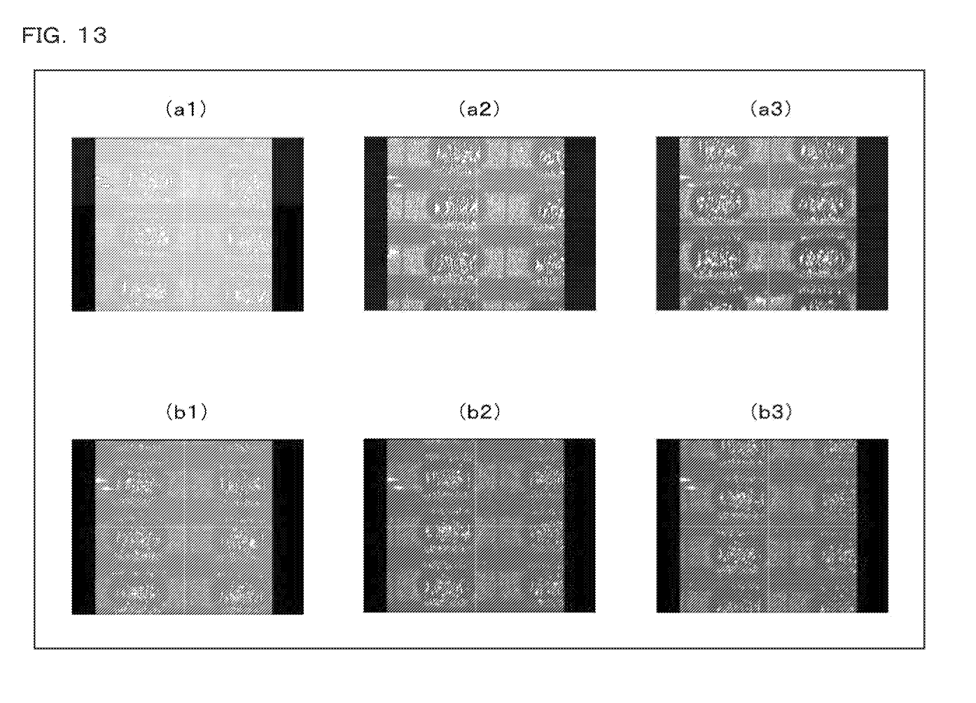

FIG. 13 is a view showing one example of a photographed image by the camera 56 of FIG. 2, where (a1) to (a3) in the figure show photographed images photographed without using the aperture 532 for the illumination light source 53, and (b1) to (b3) show photographed images photographed using the aperture 532.

The illumination light emitted from the illumination light source 53 is reflected by the XY scanner 47 through the half mirror 54 and the polarized beam splitter 46 to enter the telecentric lens 48. In this case, the shallower the incident angle with respect to the telecentric lens 48, the light quantity of the illumination light reflected at the surface of the optical lens configuring the telecentric lens 48 and following back the light receiving path of the camera 56 increases, and hence the photographed image becomes white. Such a phenomenon is called the lens flare. That is, if the scan angle by the XY scanner 47 is shallow, the luminance level of the photographed image is saturated by the influence of the lens flare thus causing whiteness.

In FIGS. 13, (a1) and (b1) are photographed images of the case in which the vicinity of the middle of the printable area is photographed with the scan angle as 0°. In the photographed image of (a1) in which the aperture 532 is not used for the illumination light source 53, the entire image is white due to the influence of the lens flare. On the other hand, in the photographed image of (b1) in which the aperture 532 is used, the influence of the lens flare is suppressed low, and the surface state of the workpiece W can be identified.

In FIGS. 13, (a2) and (b2) are photographed images of the case in which the scan angle is about half of the upper limit. The influence of the lens flare is reduced as compared to the cases of (a1) and (b1). In addition, (a3) and (b3) are photographed images of the case in which the vicinity of the outer edge of the printable area is photographed with the scan angle as the upper limit. The influence of the lens flare is further reduced as compared to the case of (a2) and (b2). In other words, the influence of the lens flare is significant the shallower the scan angle, but in any case, the image photographed using the aperture 532 is known to obtain a clearer photographed image.

According to the present embodiment, the illumination light having the wavelength substantially the same as the laser light L can be applied to the processing target through the optical path substantially coaxial with the laser light L, and the return light from the processing target can be photographed with the camera 56. Thus, a clear photographed image less likely to be subjected to the influence of chromatic aberration and the like can be obtained using an optical system optimized with respect to the wavelength of the laser light.

Furthermore, according to the present embodiment, the damage of the camera 56 by the laser light L can be prevented by blocking the return light of the laser light L reflected by the processing target using the camera shutter 55. In particular, by arranging the camera shutter 55 on the camera 56 side than the polarized beam splitter 46, the intensity of the laser light applied to the processing target can be suppressed from lowering.

Moreover, according to the present embodiment, since the wavelength selecting filter 566 for selectively passing the wavelength substantially the same as the laser light is arranged on the light receiving path of the camera 56, the unnecessary wavelength can be prevented from entering the camera and the return light having the wavelength substantially the same as the laser light L can be photographed to obtain a clear photographed image.

According to the present embodiment, the accuracy of the laser processing can be enhanced and the photographed image with less distortion can be obtained by using the telecentric lens 48.

In the present embodiment, there has been described an example in which the SHG laser oscillator is used, but the present invention is not limited thereto. For example, the present invention can be applied to a laser processing device that uses a fiber laser in which a fiber doped with Yb (ytterbium) is used as an amplifier.

What is claimed is:

1. A laser processing device comprising:
a laser generator for generating laser light for processing a processing target;
a camera for photographing the processing target;
a camera optical splitter for making a light receiving axis of the camera substantially coincide with an emission axis of the laser light;
an illumination light source for generating illumination light having a wavelength substantially the same as the laser light, the illumination light source having an emission axis that substantially coincides with the emission axis of the laser light; and
a camera shutter for blocking return light from the processing target in an openable/closable manner, the camera shutter being arranged on the camera side than the camera optical splitter.

2. The laser processing device according to claim 1, further comprising a wavelength selecting member for selectively passing a wavelength substantially the same as the illumination light, the wavelength selecting member being arranged on a light receiving path of the camera.

3. The laser processing device according to claim 1, further comprising:
a scanner for scanning the emission axis of the laser light with respect to the processing target; wherein
the camera optical splitter is arranged on the laser generator side than the scanner.

4. The laser processing device according to claim 3, further comprising a telecentric lens for making an emission angle of the laser light constant irrespective of an incident angle of the laser light, the telecentric lens being arranged on the processing target side than the scanner.

5. The laser processing device according to claim 1, further comprising an illumination optical splitter for making the emission axis of the illumination light source substantially coincide with the light receiving axis of the camera, the illumination optical splitter being arranged on the camera side than the camera optical splitter.

6. The laser processing device according to claim 5, wherein the illumination optical splitter transmits the return light from the processing target to the camera, and reflects the illumination light from the illumination light source to the camera optical splitter.

7. The laser processing device according to claim 6, further comprising an optical aperture for selectively transmitting the illumination light near the emission axis, the optical aperture being arranged on the illumination light source side than the illumination optical splitter.
